(19) United States
(12) Patent Application Publication
(10) Pub. No.: US 2022/0016753 A9
(43) Pub. Date: Jan. 20, 2022

(54) POWER TOOL

(71) Applicant: TECHTRONIC CORDLESS GP, Anderson, SC (US)

(72) Inventors: Li Guo MA, Dongguan (CN); Qing Feng ZHANG, Dongguan (CN); Jun Da YANG, Dongguan (CN)

(21) Appl. No.: 16/815,427

(22) Filed: Mar. 11, 2020

(30) Foreign Application Priority Data
Mar. 13, 2019 (CN) 201920321993.0

(51) Int. Cl. B25F 5/00; F16H 57/08; F16H 57/021

(52) U.S. Cl. CPC B25F 5/001; F16H 57/021; F16H 57/082

(57) ABSTRACT

A power tool includes an output shaft, a planet carrier, and a buffer mechanism. The planet carrier is configured to be rotatably connected with the output shaft to drive the output shaft during operation, and there is a gap between an inner side surface of the planet carrier and a circumferential surface of the output shaft. A buffer mechanism is provided on at least one of the inner side surface of the planet carrier and the circumferential surface of the output shaft near the gap. The buffer mechanism is configured not to actively apply pressure to the output shaft and the planet carrier, and to buffer the impact force between the output shaft and the planet carrier, when the output shaft slides relative to the planet carrier under the action of inertial force.

### FIELD OF THE DISCLOSURE

The disclosure relates to a power tool.

### BACKGROUND OF THE DISCLOSURE

Existing power tools (such as power drills) are usually equipped with an output shaft, and a self-locking mechanism is provided on the output shaft. During normal operation, the output shaft rotates under the driving of the power drive system, and the self-locking mechanism is not activated. At this time, the output shaft transmits torque. During the shutdown process, the self-locking mechanism locks the output shaft. In order to enable the self-locking mechanism to switch between the self-locking state and non-self-locking state, there is usually a gap between the self-locking mechanism and the output shaft. When the motor comes to an emergency stop (such as a power outage or other emergency situations), the output shaft will collide with the self-locking mechanism with inertia, resulting in a strong impact. This not only gives rise to hidden safety hazards, but is also detrimental to the life of power tools.

### SUMMARY OF THE DISCLOSURE

In view of the above-mentioned shortcomings of the art, the disclosure provides a power tool with a novel design and technical effects.

According to an aspect of the disclosure, a power tool is provided. The power tool contains an output shaft, a planet carrier, and a buffer mechanism. The planet carrier is configured to be rotatably connected with the output shaft to drive the output shaft during operation, and there is a gap between an inner side surface of the planet carrier and a circumferential surface of the output shaft. The buffer mechanism is provided on at least one of the inner side surface of the planet carrier and the circumferential surface of the output shaft near the gap. The buffer mechanism is configured not to actively apply any pressure to the output shaft and the planet carrier, and to buffer the impact force between the output shaft and the planet carrier when the output shaft slides relative to the planet carrier under the action of inertial force.

According to an aspect of the disclosure, a power tool is provided. The power tool contains an output shaft, a planet carrier, and a buffer mechanism. The planet carrier is configured to be rotatably connected to the output shaft to drive the output shaft during operation, and there is a gap between an inner side surface of the planet carrier and a circumferential surface of the output shaft. A buffering mechanism is provided on at least one of the inner side surface of the planet carrier and the circumferential surface of the output shaft near the gap. The buffer mechanism is a single member and is configured to buffer the impact force between the output shaft and the planet carrier, when the output shaft slides relative to the planet carrier under the action of inertial force.

According to another aspect of the disclosure, a power tool is provided. The power tool contains a housing, a planet carrier, an outer support ring, a cam disk, a locking pin, and soft rubber. The outer support ring is fixed on the housing. The cam disk is provided in the outer support ring and is coaxial with the outer support ring. The lock pin is provided between the outer support ring and the cam disk. The output shaft is fixedly connected to the cam disk. There is a gap between a circumferential surface of the output shaft and an inner side surface of the planet carrier, and the soft rubber is provided on at least one of the inner side surface of the planet carrier and the circumferential surface of the output shaft near the gap. The soft rubber is configured to buffer the impact force between the output shaft and the planet carrier, when the output shaft slides relative to the planet carrier under the action of inertial force.

Comparing with prior art, the power tool according to the disclosure has many advantages. For example, by using the provided buffer mechanism as the impact surface, the effect of shock absorption and noise reduction is good, and it may even achieve no impact sound. Due to existence of the buffer mechanism, undesired force between the planet carrier and the output shaft is greatly reduced, damage to the planet carrier and the output shaft is avoided, and the life of the power tool is prolonged. At the same time, it also reduces or eliminates noise generated by the impact, and increases comfort of the personnel in the working environment of the power tool. The buffer mechanism structure can be a single member, rather than an assembly of two or more components, so its structure is very simple, the cost is low, and it is easy to install and remove. The design is also very flexible. For example, it can be made into a full circle, sphere, column, block, or other shape according to actual needs, and it can be a surface contact type or a point contact type. Moreover, the buffer mechanism does not actively apply any pressure to the planet carrier and the output shaft, so when the power tool works normally, the buffer mechanism will not generate undesired resistance to it. Therefore the normal start and operation of the power tool will not be affected. In addition, according to the disclosure, the buffer mechanism can be mounted on the planet carrier or the output shaft, or both, as required, which is very flexible. There are no strict requirements on the specifications of the planet carrier and output shaft (such as size, shape, etc.), so it is very convenient and with a wide range of technical application prospects.

More embodiments and beneficial technical effects of the disclosure will be described in detail below.

### BRIEF DESCRIPTION OF THE DRAWINGS

FIG. 1 is a structural schematic diagram according to an embodiment of the disclosure.

FIG. 2 is a structural cross-sectional view according to an embodiment of the disclosure.

FIG. 3 is an exploded schematic diagram according to an embodiment of the disclosure.

FIG. 4 is a relationship diagram between a planet carrier and an output shaft when a power tool is operating reversely, according to an embodiment of the disclosure.

FIG. 5 is a schematic view of the mechanism of FIG. 4 as viewed in the direction of the output shaft to the planet carrier.

FIG. 6 is a relationship diagram between a planet carrier and an output shaft when a power tool is stopped according to an embodiment of the disclosure.

FIG. 7 is a schematic view of the mechanism of FIG. 6 as viewed in the direction of the output shaft to the planet carrier.

### DETAILED DESCRIPTION

In order to facilitate understanding of the disclosure, a plurality of exemplary embodiments will be described below with reference to the related drawings. It should be understood by those skilled in the art that the embodiments herein are only for the purpose of illustrating the disclosure, and are not a limitation on the disclosure.

As used herein, the term “power tool” may refer to a generic power tool, such as a power drill, or a part of the power tool described, such as a power drill roller overrunning clutch.

As used herein, “actively applying pressure” by component A to component B generally refers to the situation where, due to the configuration of the component A itself, company A will actively apply force to the component B which is in contact with the component A to maintain itself in a certain state S. In other words, if the component B does not exist, the state S of the component A cannot be maintained by itself.

As used herein, the term “single member” refers to an assembly made up of one part or object of the same kind, rather than two or more parts or objects of the same or different kind.

According to an embodiment of the disclosure, the structure shown in FIG. 1 comprises an output shaft 100 and a power driving mechanism 200. During normal operation, the power driving mechanism 200 provides power to drive the output shaft 100 to turn round or rotate, thereby outputting the power to achieve a certain technical effect, such as driving a nail into an object.

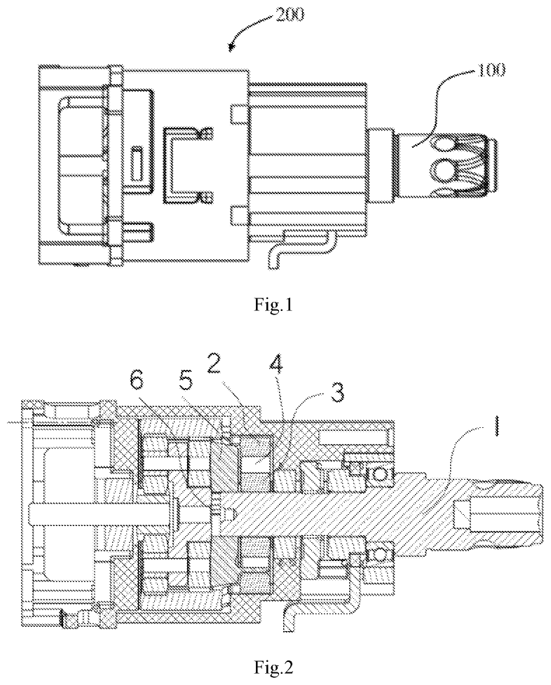

FIG. 2 is a structural cross-sectional view according to an embodiment of the disclosure. The power tool shown in FIG. 2 comprises an output shaft 1, an outer support ring 2, a cam disc 3, a lock pin 4, a planet carrier 5, and a buffer mechanism 6. The outer support ring 2, the cam disc 3, the lock pin 4, the planet carrier 5, and the buffer mechanism 6 may constitute, for example, the power driving mechanism 200 shown in FIG. 1.

Referring to FIG. 2, the outer support ring 2 is provided on the planet carrier 5. The outer support ring 2 is fixed on a housing of the power tool, the output shaft 1 and the cam disc 3 are fixed together, and the lock pin 4 is provided between the cam disc 3, the planet carrier 5 and the outer support ring 2. The planet carrier 5 is rotatably connected to the output shaft 1 to drive the output shaft 1 to output power. When the planet carrier 5 drives the output shaft 1, the lock pin 4 is loosened. When the power tool stops operating, the output shaft 1 rotates a certain angle relative to the planet carrier 5 and impacts the planet carrier 5, where the lock pin 4 is locked by the cam disc 3 and the outer support ring 2, so that the output shaft 1 stops operating.

There is a gap or empty position between the planet carrier 5 and the output shaft 1. The buffer mechanism 6 is provided on the inner side of the planet carrier 5 near the gap. The buffer mechanism 6 does not actively apply any pressure to the output shaft 1 and the planet carrier 5. When the power tool stops operating, the output shaft 1 slides relative to the planet carrier 5 under the action of inertia force, and the buffer mechanism 6 can buffer the impact force generated between the output shaft 1 and the planet carrier 5 at this time. When the power tool is started and normally operating, the buffer mechanism 6 does not apply resistance to the output shaft 1 and therefore does not generate undesired resistance.

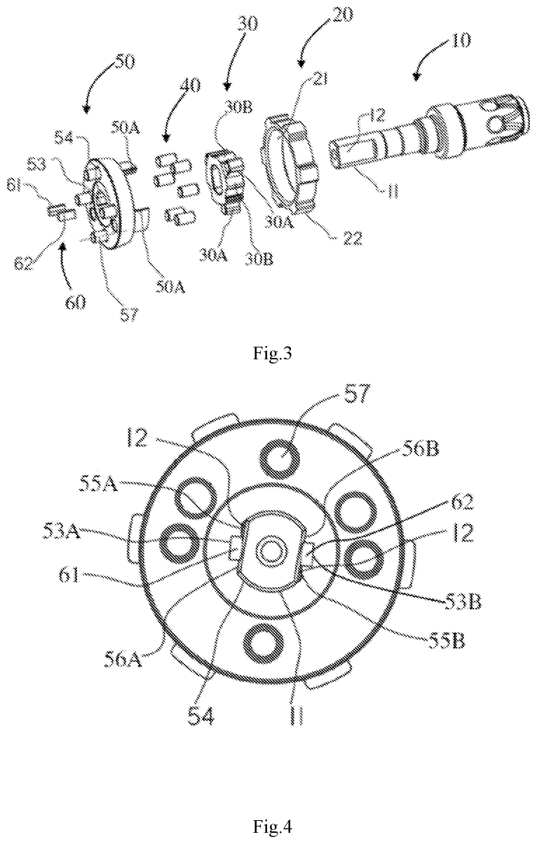

FIG. 3 is an exploded schematic diagram according to an embodiment of the disclosure. The structure shown in FIG. 3 may be an example of the structure shown in FIG. 2, for example.

As shown in FIG. 3, the power tool includes an output shaft 10, an outer support ring 20, a cam disc 30, a lock pin 40, a planet carrier 50, and a buffer mechanism 60. The outer support ring 20 and the cam disk 30 are provided on the planet carrier 50, and the cam disk 30 is provided in the outer support ring 20 and is coaxial with the outer support ring 20. The cam disc 30 can be fixedly connected to the output shaft 10 to rotate together with the output shaft 10. A transmission ridge 50A is provided on a side of the planet carrier 50 near the cam disk 30, and a stop tooth 30A and a self-locking surface 30B are provided on a circumferential surface of the cam disk 30. The transmission ridge 50A, the stop tooth 30A, and the lock pin 40 are in a space between the inner side surface 21 of the outer support ring 20 and the outer circumferential surface of the cam disc 30, the lock pin 40 is in this space and between the transmission ridge 50A and the stop tooth 30A. The planet carrier 50 is further provided with a driving column 57. When the driving column 57 receives the force of the planet wheel, the planet carrier 50 can be driven to rotate, and the output shaft 10 can be driven to rotate by the interaction with the cam disc 30. The outer support ring 20 is provided with a protrusion 22 for restricting the rotation of the outer support ring 20.

An outer positioning surface 11 and an outer anti-sliding surface 12 are formed on the circumferential surface of the output shaft 10. An inner anti-sliding surface 53 and an inner positioning surface 54 are formed on the inner side surface of the planet carrier 50. When the output shaft 10 is connected to the planet carrier 50, the inner anti-sliding surface 53 corresponds to the outer anti-sliding surface 12, and the inner positioning surface 54 corresponds to the outer positioning surface 11. A buffer mechanism 60 is provided on the inner anti-sliding surface 53 of the planet carrier 50. The buffer mechanism 60 includes two buffer members 61, 62, each of which is a single member, and they are respectively provided on the corresponding inner anti-sliding surfaces 53.

FIG. 4 is a relationship diagram between a planet carrier and an output shaft when a power tool is reversed, according to an embodiment of the disclosure. In this embodiment, the power tool operates reversely to the counterclockwise direction. When the power tool is reversed, the planet carrier 50 drives the output shaft 10 to rotate to output power. At this time, the outer positioning surface 11 of the output shaft 10 and the inner positioning surface 54 of the inner side surface of the planet carrier 50 are in close contact with each other for positioning. The buffer members 61, 62 are provided on the inner anti-sliding surfaces 53A, 53B. When the driving column 57 is rotated counterclockwise by the force of the planet wheel, the buffer members 61, 62 are compressed by the outer anti-sliding surface 12 and portions 56A, 56B of the inner anti-sliding surfaces 53A, 53B is in close contact with the outer anti-sliding surface 12 as a load contact surface. At this time, there is a gap or an empty position between the other portions 55A, 55B of the inner anti-sliding surfaces 53A, 53B and the outer anti-sliding surface 12, respectively.

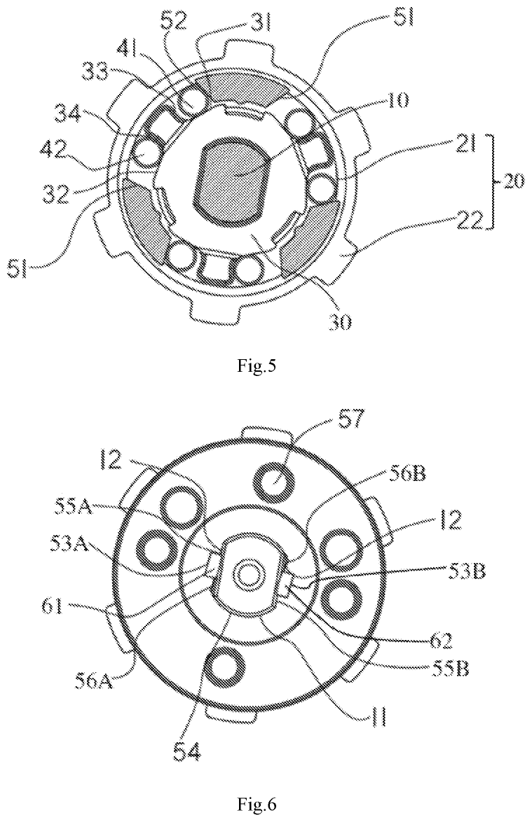

FIG. 5 is a schematic diagram of FIG. 4 viewed in the direction of the output shaft to the planet carrier. As shown, the cam disc 30 is fixed with the output shaft 10, the outer support ring 20 is fixed on the housing, and the rotation of the outer support ring 20 is restricted by the protrusion 22. One lock pin 41 of the lock pins 40 is located between one self-locking surface 31 of the self-locking surfaces 30B, one side surface 33 of the stop tooth 30A, one side surface 52 of the transmission ridge 50A, and the inner side surface 21. Due to the counterclockwise rotation, the lock pin 41 is in close contact with the inner side surface 21 and the side surface 52 and is in a loose state. The other lock pin 42 is located between the other self-locking surface 32 of the self-locking surfaces 30B, the other side surface 34 of the stop tooth 30A, the other side surface 51 of the transmission ridge 50A, and the inner side surface 21. Due to the counterclockwise rotation, the lock pin 42 is in close contact with the inner side surface 21 and the side surface 34 and is also in a loose state. At this time, the power tool can operate normally.

FIG. 6 is a relationship diagram between the planet carrier and the output shaft when the power tool is stopped. When the power tool is stopped, the output shaft 10 continues to rotate counterclockwise due to inertial force until the outer anti-sliding surface 12 disengages the portions 56A, 56B of the inner anti-sliding surface 53A, 53B and impacts another portions 55A, 55B of the inner anti-sliding surface 53A, 53B. At this time, the buffer members 61, 62 can block or buffer the impact force generated by the impact. At this time, it is different from that shown in FIG. 4 in that the other portions 55A, 55B of the inner anti-sliding surfaces 53A, 53B and the outer anti-sliding surface 12 are close contact with each other as a loaded contact surface. There is a gap or an empty position between portions 56A, 56B of the inner anti-sliding surfaces 53A, 53B and the outer anti-sliding surface 12.

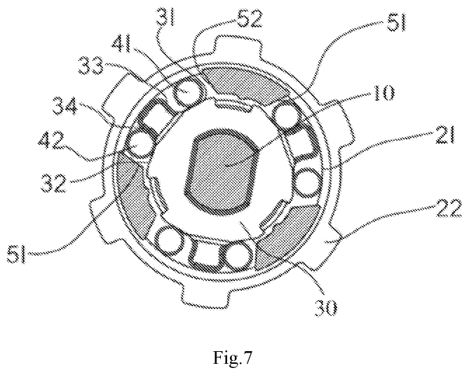

FIG. 7 is a schematic view of FIG. 6 as viewed in the direction of the output shaft to the planet carrier. At this time, the lock pin 42 is in a loose state, the side surface 52 is stopped suddenly, and it is disengaged from the lock pin 41. The lock pin 41 will be locked between the inner side surface 21 and the self-locking surface 31 and apply pressure to the cam disc 30, thereby blocking the rotation of the output shaft 10, at this time, the lock pin 41 is in a locked state.

The buffer mechanism according to the embodiment of the disclosure may comprise an elastic material. The buffer mechanism may be, for example, a soft rubber having elasticity. Soft rubber can be polypropylene (PP), polyethylene (PE), etc., whose surface hardness is relatively low. This kind of soft rubber can be formed by injection molding of plastic, and it feels softer at normal temperature. Because of its elasticity, it can absorb impacts between objects and play a buffering role. The buffer mechanism may also be formed from other appropriate elastic or flexible materials according to actual needs, as long as it can play a role in buffering the impact force.

The buffer mechanism can be provided on the inner side surface of the planet carrier in an appropriate manner. For example, the buffer mechanism may be bonded to the inside surface by an adhesive. That is, an adhesive is provided between the buffer mechanism and the inner side surface for bonding them together. A groove of an appropriate size can also be provided on the inner side surface to carry the buffer mechanism.

In addition, the shape of the buffer mechanism is highly plastic, which is also advantageous for power tools. For example, the specifications (such as size, shape, etc.) of the components of the power tool, such as the planet carrier and the output shaft, can be with low requirements. In other words, the combination of the buffer mechanism according to the embodiment is flexible and it can be used in power tools of different specifications

In addition, although the buffer mechanism shown in the above exemplary embodiment comprises two buffer members, those skilled in the art should understand that one or more than two buffer members may be provided according to actual needs. The shape of the buffer member may take other suitable shapes, such as a full circle, a sphere, a column, or other regular or irregular shapes. The contact between the buffer member and the inner side surface of the planet carrier may be a surface contact type or a point contact type.

Those skilled in the art should also understand that the buffer mechanism can be provided not only on the inner side surface of the planet carrier as illustrated, but also on the circumferential surface of the output shaft, such as the outer anti-sliding surface of the output shaft. In this case, when the output shaft slides relative to the planet carrier under the effect of the inertia force, the buffer mechanism can apply a force to the planet carrier, thereby buffering the impact between the output shaft and the planet carrier. In some embodiments, the buffer mechanism according to the disclosure can be provided on both the planet carrier and the output shaft, which is very advantageous in power tools with relatively large power, because the impact between the output shaft and the planet carrier in the power tool may be relatively strong.

Unless otherwise defined, technical and scientific terms used herein have the same meaning as commonly understood by one of those skilled in the art. Embodiments of the disclosure are illustrated in non-limiting examples. On the basis of the embodiments disclosed above, various modifications that can be conceived by those skilled in the art fall into the scope of the disclosure.

1. A power tool, comprising:
an output shaft with a circumferential surface;
a planet carrier with an inner side surface configured to be rotatably connected to the output shaft to drive the output shaft; there being a gap between the inner side surface of the planet carrier and the circumferential surface of the output shaft; and
a buffer mechanism provided on at least one of the inner side surface of the planet carrier and the circumferential surface of the output shaft near the gap; the buffer mechanism configured to not actively apply a pressure to the output shaft and the planet carrier, and to buffer the impact force between the output shaft and the planet carrier when the output shaft slides relative to the planet carrier under the action of inertial force.

2. The power tool according to claim 1, wherein the circumferential surface of the output shaft comprises an outer anti-sliding surface and an outer positioning surface; the inner side surface of the planet carrier comprising an inner anti-sliding surface and an inner positioning surface; the inner anti-sliding surface corresponding to the outer anti-sliding surface, the inner positioning surface corresponding to the outer positioning surface, and the buffer mechanism provided on the inner anti-sliding surface.

3. The power tool according to claim 1, wherein the buffer mechanism comprises two or more buffer members, each of the two or more buffer members provided on the corresponding inner anti-sliding surface of the inner side surface of the planet carrier.

4. The power tool according to claim 1, wherein the buffer mechanism comprises an elastic material.

5. The power tool according to claim 4, wherein the elastic material is soft rubber.

6. The power tool according to claim 1, wherein an adhesive is provided between the buffer mechanism and the inner side surface, and the adhesive is configured to engage the buffer mechanism and the inner side surface together.

7. The power tool according to claim 1, wherein the buffer mechanism has a spherical shape, a cylindrical shape, or a square shape.

8. The power tool according to claim 1, wherein the buffer mechanism is provided on the inner surface in a point contact manner or a surface contact manner.

9. A power tool, comprising:
an output shaft with a circumferential surface;
a planet carrier with an inner side surface configured to be rotatably connected to the output shaft to drive the output shaft; there being a gap between the inner side surface of the planet carrier and the circumferential surface of the output shaft; and
a buffer mechanism provided near the gap on at least one of the inner side surface of the planet carrier and the circumferential surface of the output shaft, the buffer mechanism being a single member and configured to buffer the impact force between the output shaft and the planet carrier when the output shaft slides relative to the planet carrier under the action of inertial force.

10. The power tool according to claim 9, wherein the buffer mechanism is soft rubber.

11. A power tool, comprising:
a housing;
a planet carrier;
an outer support ring fixed on the housing;
a cam disk provided in the outer support ring and coaxial with the outer support ring; a lock pin provided between the outer support ring and the cam disk;
an output shaft fixedly connected to the cam disk; there being a gap between a circumferential surface of the output shaft and an inner side surface of the planet carrier; and
a soft rubber provided on at least one of the inner side surface of the planet carrier and the circumferential surface of the output shaft near the gap; the soft rubber configured to buffer the impact force between the output shaft and the planet carrier when the output shaft slides relative to the planet carrier under the action of inertial force.
